(19) United States
(12) Patent Application Publication
(10) Pub. No.: US 2025/0344137 A1
(43) Pub. Date: Nov. 6, 2025

(54) TERMINATION OF ON-DEMAND SSB TRANSMISSIONS

(71) Applicant: Samsung Electronics Co., Ltd., Suwon-si (KR)

(72) Inventor: Hongbo Si, Allen, TX (US)

(21) Appl. No.: 19/189,089

(22) Filed: Apr. 24, 2025

Related U.S. Application Data
(60) Provisional application No. 63/642,088, filed on May 3, 2024.
(60) Provisional application No. 63/690,118, filed on Sep. 3, 2024.
(60) Provisional application No. 63/710,942, filed on Oct. 23, 2024.

(51) Int. Cl. H04W 48/14; H04W 72/0446

(52) U.S. Cl. CPC H04W 48/14; H04W 72/0446

(57) ABSTRACT

Methods and apparatuses for determination of termination of an on-demand synchronization signal block (SSB) transmission. A method includes receiving a first set of higher layer parameters that includes a set of configurations for on-demand synchronization signal and physical broadcast channel (SS/PBCH) blocks, receiving a medium access control (MAC) control element (CE), and identifying, based on the set of configurations, a set of transmitted SS/PBCH blocks in a burst. The method further includes determining a last transmitted SS/PBCH block in the burst, identifying, based on the MAC CE, a first indication of deactivation of transmission for the on-demand SS/PBCH blocks, determining a first slot corresponding to T slots after a slot where the MAC CE ends, and determining, based on whether the first slot includes a transmitted SS/PBCH block in the burst, a second slot as an end of the transmission for the on-demand SS/PBCH blocks.

### CROSS-REFERENCE TO RELATED APPLICATIONS AND CLAIM OF PRIORITY

The present application claims priority to: U.S. Provisional Patent Application No. 63/642,088, filed on May 3, 2024; U.S. Provisional Patent Application No. 63/690,118, filed on Sep. 3, 2024; and U.S. Provisional Patent Application No. 63/710,942, filed on Oct. 23, 2024. The contents of the above-identified patent documents are incorporated herein by reference.

### TECHNICAL FIELD

The present disclosure relates generally to wireless communication systems and, more specifically, the present disclosure relates to a determination of termination of an on-demand synchronization signal block (SSB) transmission in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to a determination of termination of an on-demand SSB transmission in a wireless communication system.

In one embodiment, a user equipment (UE) in a wireless communication system is provided. The UE includes a transceiver configured to receive a first set of higher layer parameters, where the first set of higher layer parameters includes a set of configurations for on-demand synchronization signal and physical broadcast channel (SS/PBCH) blocks, and receive a medium access control (MAC) control element (CE). The UE further includes a processor operably coupled to the transceiver. The processor is configured to identify, based on the set of configurations, a set of transmitted SS/PBCH blocks in a burst, determine a last transmitted SS/PBCH block in the burst, identify, based on the MAC CE, a first indication of deactivation of transmission for the on-demand SS/PBCH blocks, determine a first slot corresponding to T slots after a slot where the MAC CE ends, where T is a positive integer, and determine, based on whether the first slot includes a transmitted SS/PBCH block in the burst, a second slot as an end of the transmission for the on-demand SS/PBCH blocks.

In another embodiment, a base station (BS) in a wireless communication system is provided. The BS includes a processor configured to determine a first set of higher layer parameters, where the first set of higher layer parameters includes a set of configurations for on-demand SS/PBCH blocks, identify, based on the set of configurations, a set of transmitted SS/PBCH blocks in a burst, determine a last transmitted SS/PBCH block in the burst, and determine a first indication of deactivation of transmission for the on-demand SS/PBCH blocks. The BS further includes a transceiver operably coupled to the processor. The transceiver is configured to transmit the first set of higher layer parameters and transmit a MAC CE including the first indication, The processer further configured to determine a first slot corresponding to T slots after a slot where the MAC CE ends, where T is a positive integer, and determine, based on whether the first slot includes a transmitted SS/PBCH block in the burst, a second slot as an end of the transmission for the on-demand SS/PBCH blocks.

In yet another embodiment, a method of a UE in a wireless communication system is provided. The method includes receiving a first set of higher layer parameters, wherein the first set of higher layer parameters includes a set of configurations for on-demand SS/PBCH blocks, receiving a MAC CE, and identifying, based on the set of configurations, a set of transmitted SS/PBCH blocks in a burst. The method further includes determining a last transmitted SS/PBCH block in the burst, identifying, based on the MAC CE, a first indication of deactivation of transmission for the on-demand SS/PBCH blocks, determining a first slot corresponding to T slots after a slot where the M A C CE ends, where T is a positive integer, and determining, based on whether the first slot includes a transmitted SS/PBCH block in the burst, a second slot as an end of the transmission for the on-demand SS/PBCH blocks.

Other technical features may be readily apparent to one skilled in the art from the figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate examples of wireless transmit and receive paths according to this disclosure;

FIG. 6 illustrates an example of on-demand SSB transmission indicated by gNB according to embodiments of the present disclosure;

FIG. 7 illustrates an example of on-demand SSB transmission pattern according to embodiments of the present disclosure;

FIG. 8 illustrates another example of on-demand SSB transmission pattern according to embodiments of the present disclosure;

FIG. 9 illustrates yet another example of on-demand SSB transmission pattern according to embodiments of the present disclosure;

FIG. 10 illustrates yet another example of on-demand SSB transmission pattern according to embodiments of the present disclosure;

FIG. 11 illustrates yet another example of on-demand SSB transmission pattern according to embodiments of the present disclosure;

FIG. 12 illustrates yet another example of on-demand SSB transmission pattern according to embodiments of the present disclosure;

FIG. 13 illustrates a flowchart of UE method for an on-demand SSB according to embodiments of the present disclosure; and

FIG. 14 illustrates another flowchart of UE method for an on-demand SSB according to embodiments of the present disclosure.

### DETAILED DESCRIPTION

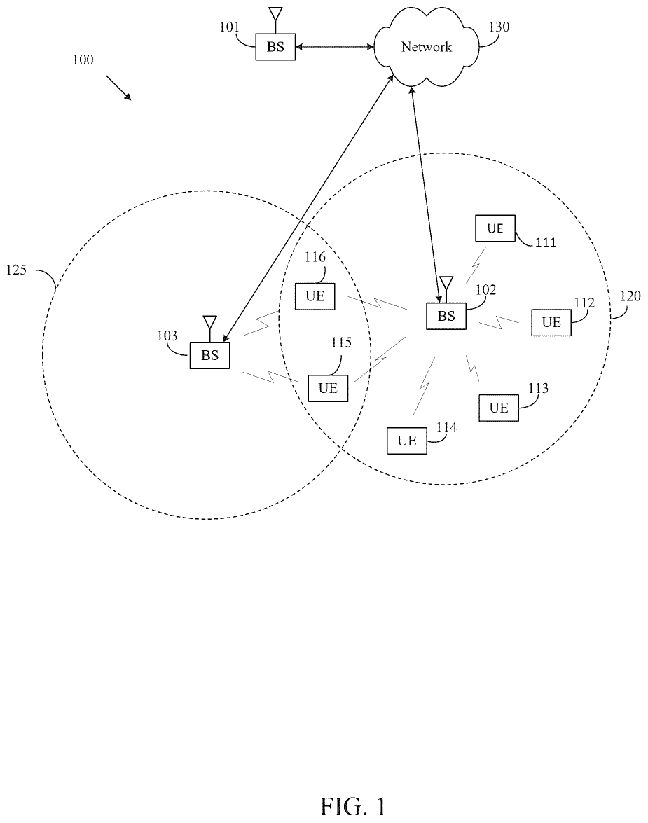

FIGS. 1-14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RA Ns), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v17.1.0, “NR; Physical channels and modulation”; 3GPP TS 38.212 v17.1.0, “NR; Multiplexing and channel coding”; 3GPP TS 38.213 v17.1.0, “NR; Physical layer procedures for control”; 3GPP TS 38.214 v17.1.0, “NR; Physical layer procedures for data”; and 3GPP TS 38.331 v17.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a Wifi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a determination of termination of an on-demand SSB transmission in a wireless communication system. In certain embodiments, and one or more of the gNBs 101-103 includes circuitry, programing, or a combination thereof, for supporting an operation for configurations for a determination of termination of an on-demand SSB transmission in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

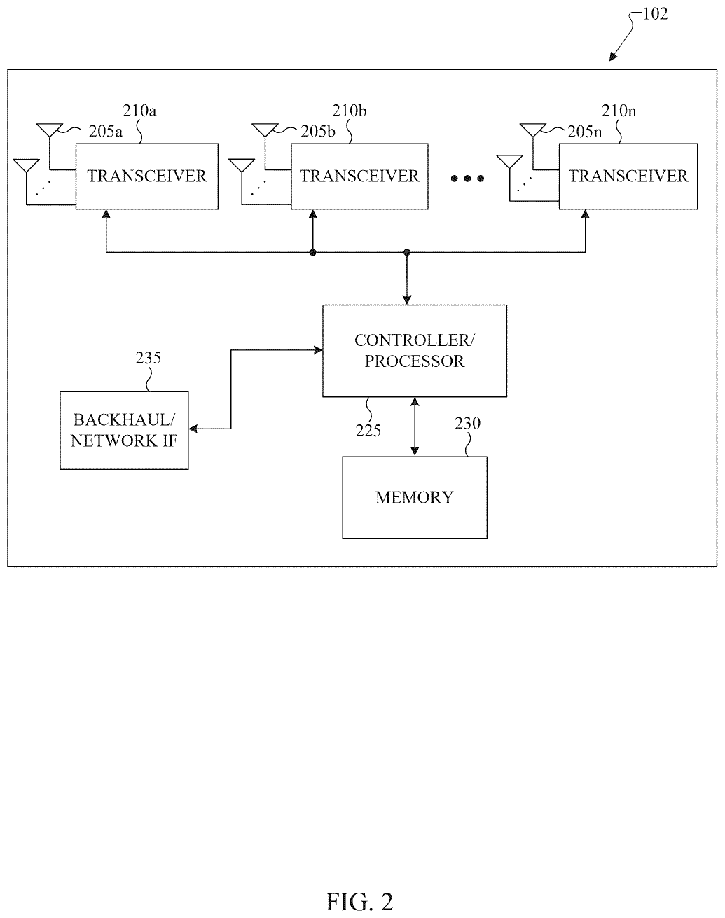

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNB s come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting a determination of termination of an on- demand SSB transmission in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

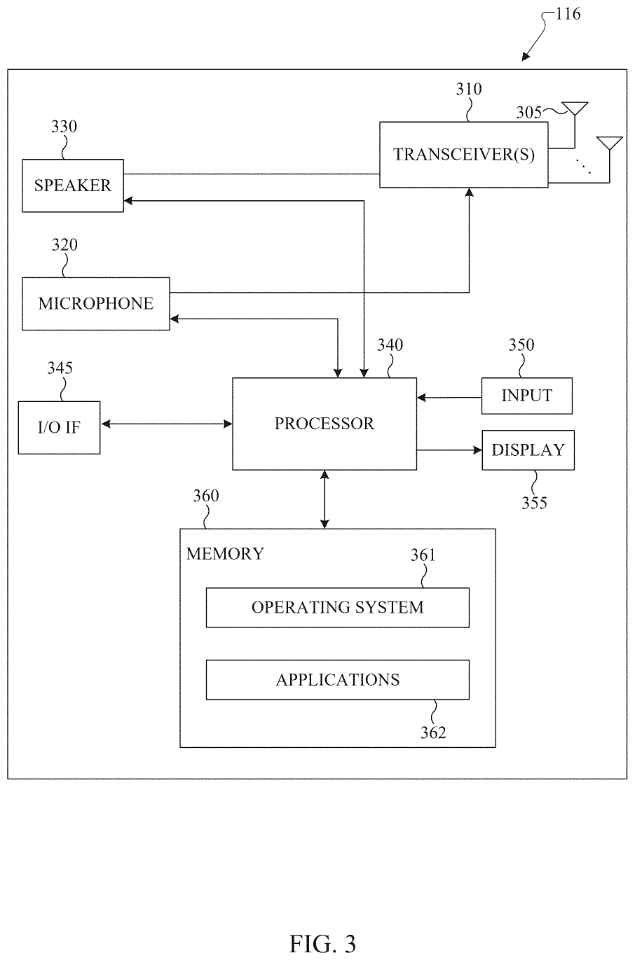

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e- mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a determination of termination of an on-demand SSB transmission in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

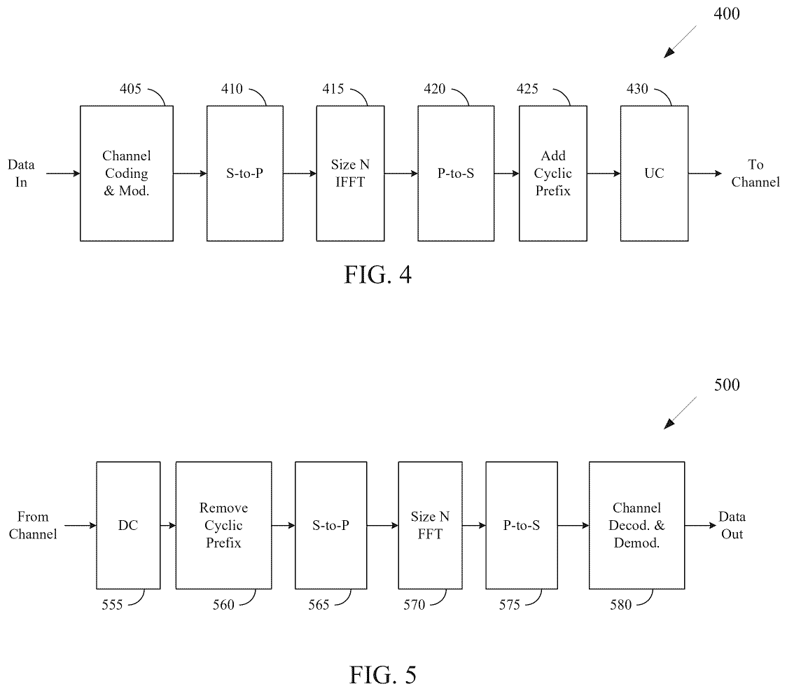

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In various embodiments, the receive path 500 can be implemented in a first UE and the transmit path 400 can be implemented in a second UE. In some embodiments, the receive path 500 is configured to a determination of termination of an on-demand SSB transmission in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101- 103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In NR, for a SCell implemented with periodic SS/PBCH block transmission, a UE can be provided with a configuration for radio resource management (RRM) measurement based on the periodic SS/PBCH block, wherein the configuration can be provided by a RRC parameter. After the RRM measurement, the gNB can provide a configuration of the SCell, e.g., by another RRC parameter. The UE can be further provided with a MAC CE indicating an activation of the SCell, and by using the periodic SS/PBCH blocks on the SCell, or TRS if configured, or the SS/PBCH blocks on the PCell when the SCell is without periodic SS/PBCH block transmission, the UE can get synchronized with the SCell and get ready to transmit or receive on the SCell. After activation of the SCell, if the SCell gets loss of synchronization, the UE can use the periodic SS/PBCH block for resynchronization. Since SS/PBCH block is transmitted on the SCell periodically, the power consumption for SS/PBCH block can be significantly large. To reduce the power consumption, on- demand SSB can be supported on the SCell.

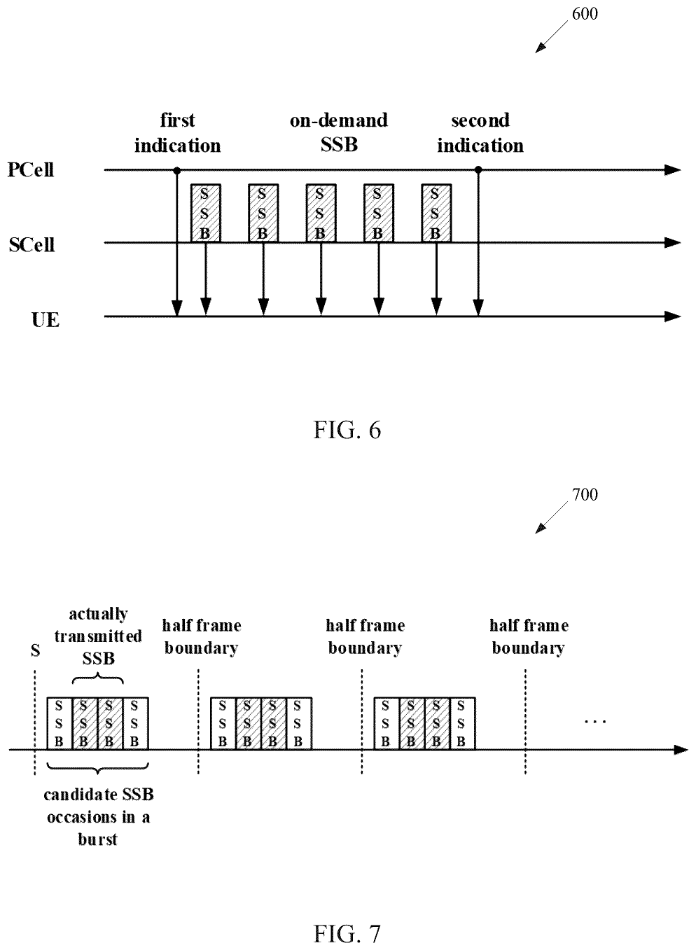

In one example, on-demand SSB(s) can be triggered to be transmitted by a first indication (e.g., a first DCI format, a first MAC CE, or a first higher layer parameter) from the gNB and/or triggered to be terminated by a second indication (e.g., a second DCI format, a first MAC CE, or a first higher layer parameter) from the gNB. For some example procedures, the second indication can be absent, and the UE assumes the triggered on-demand SSB transmission is not terminated, e.g., periodic manner after triggered, or terminated by a number of transmission bursts, e.g., as described in the example of this disclosure. An illustration of the on-demand SSB triggered by gNB is shown FIG. 6.

FIG. 6 illustrates an example of on-demand SSB transmission indicated by gNB 600 according to embodiments of the present disclosure. An embodiment of the on-demand SSB transmission indicated by gNB 600 shown in FIG. 6 is for illustration only.

The present disclosure includes the design details on determining the transmission pattern and/or ending time of the transmission for the on-demand SSB. The following notations are used in the disclosure, wherein the corresponding component can be fixed in the specification (e.g., a pre-defined value), or included in at least one indication (e.g., a DCI format, and/or a MAC CE (with candidate values pre-defined or provided by R RC parameters), and/or RRC parameters): (i) O′: a time domain offset for the on-demand SSB transmission; (ii) I: a time domain interval or periodicity for the on-demand SSB transmission burst; (iii) N: a time duration or a number of transmission bursts for the on-demand SSB transmission; and (iv) t_delay: a feedback reception time for the indication and/or a minimum processing time of the terminating and/or preparation for stopping the on-demand SSB transmission.

In one example, when the indication/trigger is a MAC CE, then the timing refers to the minimum processing time of the MAC CE and/or preparation for stopping the on-demand SSB transmission.

In one example, when the indication/trigger is a DCI format, then the timing refers to the minimum processing time of the DCI format and/or preparation for stopping the on-demand SSB transmission.

In one example, when the indication/trigger is a RRC parameter, then the timing refers to the minimum processing time of the RRC parameter and/or preparation for stopping the on-demand SSB transmission.

In one example, t_proc can be same as or no less than the minimum processing time for SCell activation and/or deactivation using MAC CE, when the indication/trigger is a MAC CE.

In one example, t_proc can be same as or no less than the minimum processing time for SCell activation and/or deactivation using RRC parameter, when the indication/trigger is a RRC parameter.

In one example, before the time instance that the UE determines as the ending time of the on-demand SSB transmission, or the UE determines as the starting time that the on-demand SSB transmission is terminated, the UE may perform Layer 1 measurement and/or Layer 3 measurement based on the on-demand SSB. After the time instance that the UE determines as the ending time of the on-demand SSB transmission, or the UE determines as the starting time that the on-demand SSB transmission is terminated, the UE may not perform Layer 1 measurement and/or Layer 3 measurement based on the on-demand SSB.

The present disclosure focuses on determining the transmission pattern and ending time for on-demand SSB transmission, with or without an explicit indication on the time offset for the on-demand SSB transmission. More precisely, the following aspects are included in the present disclosure: (1) periodic transmission pattern for on-demand SSB; (2) determining the ending time based on gNB's indication: (a) using a half frame as a transmission unit and without explicit indication of a time offset, (b) using a half frame as a transmission unit and with explicit indication of a time offset, (c) using a slot as a transmission unit and without explicit indication of a time offset, (d) using a slot as a transmission unit and with explicit indication of a time offset, and (e) example UE procedure; (3) determining the ending time based on UE's triggering: (a) using a half frame as a transmission unit and without explicit indication of a time offset, (b) using a half frame as a transmission unit and with explicit indication of a time offset, (c) using a slot as a transmission unit and without explicit indication of a time offset, and (d) using a slot as a transmission unit and with explicit indication of a time offset; and (4) example UE procedures.

In one embodiment, a periodic transmission pattern for the on-demand SS/PBCH block is provided.

In one embodiment, a UE can assume the on-demand SSB transmission is in a periodic manner, e.g., after being indicated that the on-demand SSB transmission is activated.

In one example, assuming on-demand SSB transmission starts from half frame S (e.g., the first on-demand SSB transmission is within half frame S), then the UE assumes the on-demand SSB transmission occurs in half frame S+n, wherein n is an integer taking value of 0, 1, 2, and so on. An illustration of the example is shown in FIG. 7. At least one of the examples, embodiments, and/or instances, or combination of thereof as provided in the present disclosure, can be applicable to the example.

FIG. 7 illustrates an example of on-demand SSB transmission pattern 700 according to embodiments of the present disclosure. An embodiment of the on-demand SSB transmission pattern 700 shown in FIG. 7 is for illustration only.

In one further evaluation, this example can be applicable when the UE is not provided with a periodicity or an interval for the on-demand SSB transmission bursts.

In one further evaluation, this example can be applicable when the UE is not provided with a time duration for the on-demand SSB transmission (e.g., a number of half frames or a number of bursts).

In one further evaluation, this example can be applicable when there is no periodic SSB transmission on the cell that supports on-demand SSB transmission.

In one further evaluation, this example can be applicable when the cell that supports on-demand SSB transmission is not configured with a reference cell with periodic SSB transmission.

In one further evaluation, this example can be applicable when the UE has not received any indication on deactivating the on-demand SSB transmission or deactivating the SCell.

In one further evaluation, this example can be applicable when the first indication that indicates the activation of the on-demand SSB transmission is the first RRC parameter.

In one further evaluation, the on-demand SSB transmission can be subject to an indication of actually transmitted SSB within the burst (e.g., further within the half frame), such that a subset of the candidate SSB occasions in the burst are used for actual on-demand SSB transmission.

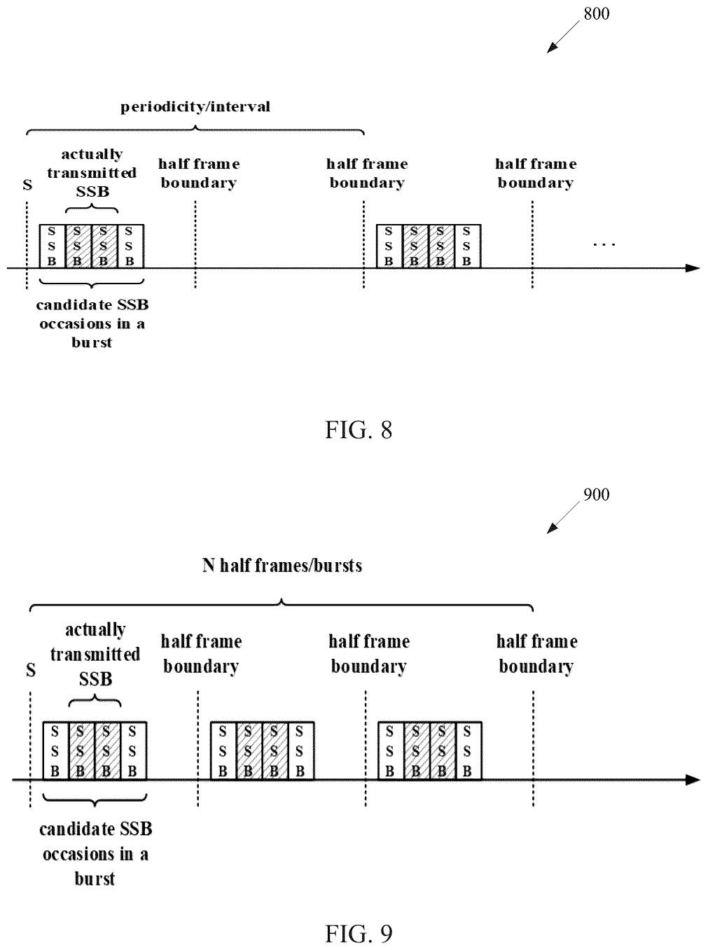

In one example, assuming on-demand SSB transmission starts from half frame S (e.g., the first on-demand SSB transmission is within half frame S), and the UE determines an interval or a periodicity for the on-demand SSB transmission bursts (e.g., denoted as I, and, in one example, the unit of I is a half frame or a SSB transmission burst), then the UE assumes the on-demand SSB transmission occurs in half frame S+I*n, wherein n is an integer taking value of 0, 1, 2, and so on. An illustration of the example is shown in FIG. 8 At least one of the examples, embodiments, and/or instance, or a combination of thereof as provided in the present disclosure, can be applicable to the example.

FIG. 8 illustrates another example of on-demand SSB transmission pattern 800 according to embodiments of the present disclosure. An embodiment of the on-demand SSB transmission pattern 800 shown in FIG. 8 is for illustration only.

In one further evaluation, this example can be applicable when the UE is not provided with a time duration for the on-demand SSB transmission (e.g., a number of half frames or a number of bursts).

In one further evaluation, this example can be applicable when there is no periodic SSB transmission on the cell that supports on-demand SSB transmission.

In one further evaluation, this example can be applicable when the cell that supports on- demand SSB transmission is not configured with a reference cell with periodic SSB transmission.

In one further evaluation, this example can be applicable when the UE has not received any indication on deactivating the on-demand SSB transmission or deactivating the SCell.

In one further evaluation, this example can be applicable when the first indication that indicates the activation of the on-demand SSB transmission is the first RRC parameter.

In one further evaluation, the on-demand SSB transmission can be subject to an indication of actually transmitted SSB within the burst (e.g., further within the half frame), such that a subset of the candidate SSB occasions in the burst are used for actual on-demand SSB transmission.

In one example, assuming on-demand SSB transmission starts from half frame S (e.g., the first on-demand SSB transmission is within half frame S), and the UE determines a time duration or a number of SSB transmission bursts for the on-demand SSB transmission (e.g., denoted as N, and, in one example, the unit of N is a half frame or a SSB transmission burst), then the UE assumes the on-demand SSB transmission occurs in half frame S+n, wherein n is an integer taking value of 0, 1, 2, . . . , N−1. An illustration of the example is shown in FIG. 9. At least one of the examples, embodiment, and/or instance, or a combination of thereof as provided in the present disclosure, can be applicable to the example.

FIG. 9 illustrates yet another example of on-demand SSB transmission pattern 900 according to embodiments of the present disclosure. An embodiment of the on-demand SSB transmission pattern 900 shown in FIG. 9 is for illustration only.

In one further evaluation, this example can be applicable when the UE is not provided with a time interval or a periodicity for the on-demand SSB transmission.

In one further evaluation, this example can be applicable when there is periodic SSB transmission on the cell that supports on-demand SSB transmission.

In one further evaluation, this example can be applicable when the cell that supports on- demand SSB transmission is configured with a reference cell with periodic SSB transmission.

In one further evaluation, this example can be applicable when the UE has not received any indication on deactivating the on-demand SSB transmission or deactivating the SCell.

In one further evaluation, this example can be applicable when the first indication that indicates the activation of the on-demand SSB transmission is the first RRC parameter.

In one further evaluation, the on-demand SSB transmission can be subject to an indication of actually transmitted SSB within the burst (e.g., further within the half frame), such that a subset of the candidate SSB occasions in the burst are used for actual on-demand SSB transmission.

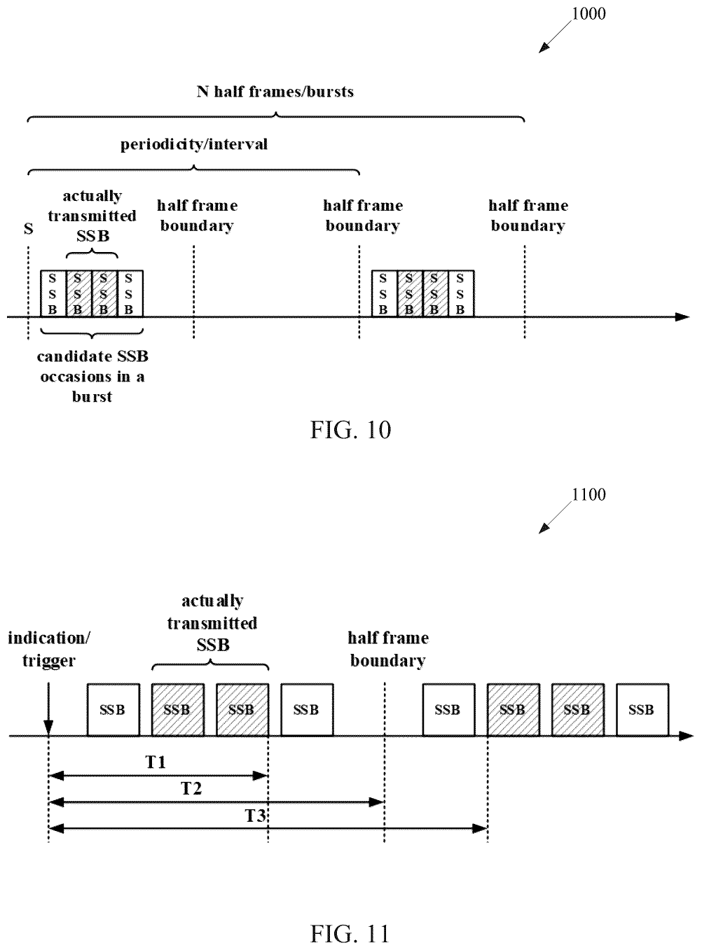

In one example, assuming on-demand SSB transmission starts from half frame S (e.g., the first on-demand SSB transmission is within half frame S), and the UE determines a time duration or a number of SSB transmission bursts for the on-demand SSB transmission (e.g., denoted as N, an interval or a periodicity for the on-demand SSB transmission (e.g., denoted as I, and, in one example, the unit of I is a half frame or a SSB transmission burst) and, in one example, the unit of N is a half frame or a SSB transmission burst), and also determines an interval or a periodicity for the on-demand SSB transmission burst (e.g., denoted as I, and, in one example, the unit of I is a half frame or a SSB transmission burst), then the UE assumes the on-demand SSB transmission occurs in half frame S+I*n, wherein n is an integer taking value of 0, 1, 2, . . . , N−1. An illustration of the example is shown in FIG. 10 At least one of the examples, embodiments, and/or instance, or a combination of thereof, as provided in the present disclosure, can be applicable to the example.

FIG. 10 illustrates yet another example of on-demand SSB transmission pattern 1000 according to embodiments of the present disclosure. An embodiment of the on-demand SSB transmission pattern 1000 shown in FIG. 10 is for illustration only.

In one further evaluation, this example can be applicable when there is periodic SSB transmission on the cell that supports on-demand SSB transmission.

In one further evaluation, this example can be applicable when the cell that supports on- demand SSB transmission is configured with a reference cell with periodic SSB transmission.

In one further evaluation, this example can be applicable when the UE has not received any indication on deactivating the on-demand SSB transmission or deactivating the SCell.

In one further evaluation, this example can be applicable when the first indication that indicates the activation of the on-demand SSB transmission is the first RRC parameter.

In one further evaluation, the on-demand SSB transmission can be subject to an indication of actually transmitted SSB within the burst (e.g., further within the half frame), such that a subset of the candidate SSB occasions in the burst are used for actual on-demand SSB transmission.

In one embodiment, a transmission ending time based on a gNB's indication is provided.

In one embodiment, a UE can determine the on-demand SSB transmission is deactivated (or no on-demand SSB is transmitted) based on gNB's indication.

In one example, the gNB's indication can be a higher layer parameter including an indication of SCell deactivation.

In one example, the gNB's indication can be a higher layer parameter including an indication of on-demand SSB transmission deactivation.

In one example, the gNB's indication can be a MAC CE including a SCell deactivation command.

In one example, the gNB's indication can be a MAC CE including an on-demand SSB transmission deactivation command.

In one example, the gNB's indication can be a DCI format including an indication of SCell deactivation.

In one example, the gNB's indication can be a DCI format including an indication of on-demand SSB transmission deactivation.

In one example, after the UE determines the on-demand SSB transmission is deactivated, the UE may not perform RRM measurement, and/or synchronization, and/or L1 measurement based on the on-demand SSB.

In one example, when multiple example(s) and/or instance(s) of this embodiment are applicable for determining the ending time of on-demand SSB, the earliest time instance among the time instances determined from the multiple example(s) and/or instance(s) is assumed by the UE.

In one example, when multiple example(s) and/or instance(s) of this embodiment are applicable for determining the ending time of on-demand SSB, the latest time instance among the time instances determined from the multiple example(s) and/or instance(s) is assumed by the UE.

In one embodiment, using a half frame as a transmission unit and without explicit indication of an offset is provided.

In one example, assuming the UE receives the gNB's indication in half frame E (or in half frames with an ending half frame as half frame E), then the UE can determine the half frame in which the on-demand SSB transmission terminates (or in which no on-demand SSB transmission starts) as E+k, wherein k can be given by at least one of the examples (e.g., k is in a unit of a half frame) as provided in the present disclosure.

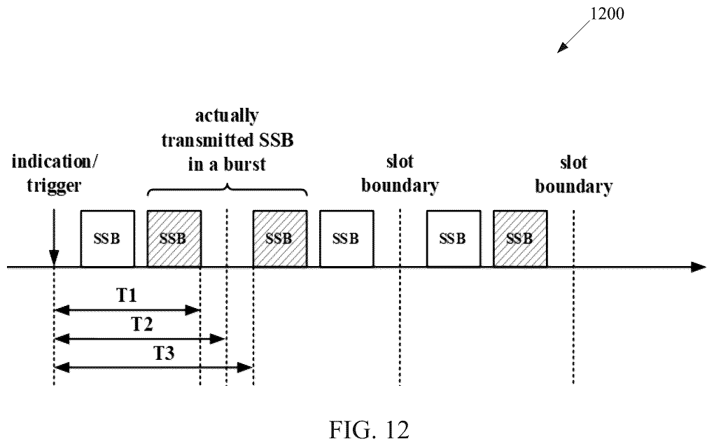

FIG. 11 illustrates yet another example of on-demand SSB transmission pattern 1100 according to embodiments of the present disclosure. An embodiment of the on-demand SSB transmission pattern 1100 shown in FIG. 11 is for illustration only.

In one example, k=0, e.g., the UE assumes on-demand SSB transmission terminates in the half frame same as the one in which the UE receives the gNB's indication.

In one example, the UE may assume all actually transmitted SSB are transmitted within the half frame E+k in which the on-demand SSB transmission terminates.

In one example, the UE may assume that the time duration from the gNB's indication (e.g., the end of the slot including the gNB's indication) to the end of the last actually transmitted SSB in the half frame E+k (e.g., T1 as illustrated in FIG. 11) can be larger than or no less than a threshold (e.g., t_delay).

In one example, the UE may assume that the time duration from the gNB's indication (e.g., the end of the slot including the gNB's indication) to the end of the half frame E+k (e.g., T2 as illustrated in FIG. 11) can be larger than or no less than a threshold (e.g., t_delay).

In one example, the UE may assume that the time duration from the gNB's indication (e.g., the end of the slot including the gNB's indication) to the start of first actually transmitted SSB in the next half frame E+k+1 (e.g., T3 as illustrated in FIG. 11) can be larger than or no less than a threshold (e.g., t_delay).

In one example, k is the minimum integer such that the time duration from the gNB's indication (e.g., the end of the slot including the gNB's indication) to the end of the last actually transmitted SSB in the half frame E+k (e.g., T1 as illustrated in FIG. 11) can be larger than or no less than a threshold (e.g., t_delay).

In one example, the UE may assume all actually transmitted SSB are transmitted within the half frame E+k in which the on-demand SSB transmission terminates.

In one example, k is the minimum integer such that the time duration from the gNB's indication (e.g., the end of the slot including the gNB's indication) to the end of the half frame E+k (e.g., T2 as illustrated in FIG. 11) can be larger than or no less than a threshold (e.g., t_delay).

In one example, the UE may assume all actually transmitted SSB are transmitted within the half frame E+k in which the on-demand SSB transmission terminates.

In one example, k is the minimum integer such that the time duration from the gNB's indication (e.g., the end of the slot including the gNB's indication) to the start of first actually transmitted SSB in the next half frame E+k+1 (e.g., T3 as illustrated in FIG. 11) can be larger than or no less than a threshold (e.g., t_delay).

In one example, the UE may assume all actually transmitted SSB are transmitted within the half frame E+k in which the on-demand SSB transmission terminates.

In one embodiment, using a half frame as a transmission unit and with explicit indication of an offset is provided.

In one example, assuming the UE receives the gNB's indication in half frame E (or in half frames with an ending half frame as half frame E), and the UE is provided with a time offset for determining the ending time of the on-demand SSB transmission (e.g., denoted by O′, which can be provided by at least one of a DCI format, a MAC CE, or a higher layer parameter), then the UE can determine the half frame in which the on-demand SSB transmission terminates (or in which no on-demand SSB transmission starts) as E+O′.

In one example, the UE may assume all actually transmitted SSB are transmitted within the half frame E+O′ in which the on-demand SSB transmission terminates.

In one example, the UE may assume the unit of the time offset O′ is a half frame or a SSB transmission burst. In one example, O′=0 refers to the case that on-demand SSB transmission terminates in the half frame same as the one in which the UE receives the gNB's indication.

In one example, the UE may assume that O′ can be larger than or no less than a threshold (e.g., t_delay).

In one example, the UE may assume that the time duration from the gNB's indication (e.g., the end of the slot including the gNB's indication) to the end of the last actually transmitted SSB in the half frame E+O′ (e.g., T1 as illustrated in FIG. 11) can be larger than or no less than a threshold (e.g., t_delay).

In one example, the UE may assume that the time duration from the gNB's indication (e.g., the end of the slot including the gNB's indication) to the end of the half frame E+O′ (e.g., T2 as illustrated in FIG. 11) can be larger than or no less than a threshold (e.g., t_delay).

In one example, the UE may assume that the time duration from the gNB's indication (e.g., the end of the slot including the gNB's indication) to the start of first actually transmitted SSB in the next half frame E+O′+1 (e.g., T3 as illustrated in FIG. 11) can be larger than or no less than a threshold (e.g., t_delay).

In one embodiment, using a slot as a transmission unit and without explicit indication of an offset is provided.

In one example, assuming the UE receives the gNB's indication in slot E (or in slots with an ending slot as slot E), then the UE can determine the slot (or a timing that is the beginning of the slot or ending of the slot) in which the on-demand SSB transmission terminates (or in which no on-demand SSB transmission starts) from E+k, wherein k can be given by at least one of the examples (e.g., k is in a unit of a slot) as provided in the present disclosure.

FIG. 12 illustrates yet another example of on-demand SSB transmission pattern 1200 according to embodiments of the present disclosure. An embodiment of the on-demand SSB transmission pattern 1200 shown in FIG. 12 is for illustration only.

In one example, k=0, e.g., the UE assumes on-demand SSB transmission terminates in the slot same as the one in which the UE receives the gNB's indication.

In one example, the UE may assume all actually transmitted SSB are transmitted within the slot E+k in which the on-demand SSB transmission terminates.

In one example, the UE may assume that the time duration from the gNB's indication (e.g., the end of the slot(s) including the gNB's indication) to the end of the last actually transmitted SSB in the slot E+k (e.g., T1 as illustrated in FIG. 12) can be larger than or no less than a threshold (e.g., t_delay).

In one example, the UE may assume that the time duration from the gNB's indication (e.g., the end of the slot(s) including the gNB's indication) to the end of the slot E+k (e.g., T2 as illustrated in FIG. 12) can be larger than or no less than a threshold (e.g., t_delay).

In one example, the UE may assume that the time duration from the gNB's indication (e.g., the end of the slot(s) including the gNB's indication) to the start of first actually transmitted SSB in the next slot E+k+1 (e.g., T3 as illustrated in FIG. 12) can be larger than or no less than a threshold (e.g., t_delay).

In one example, k is the minimum integer such that the time duration from the gNB's indication (e.g., the end of the slot(s) including the gNB's indication) to the end of the last actually transmitted SSB in the slot E+k (e.g., T1 as illustrated in FIG. 12) can be larger than or no less than a threshold (e.g., t_delay).

In one example, the UE may assume all actually transmitted SSB are transmitted within the slot E+k in which the on-demand SSB transmission terminates.

In one example, k is the minimum integer such that the time duration from the gNB's indication (e.g., the end of the slot(s) including the gNB's indication) to the end of the slot E+k (e.g., T2 as illustrated in FIG. 12) can be larger than or no less than a threshold (e.g., t_delay).

In one example, the UE may assume all actually transmitted SSB are transmitted within the slot E+k in which the on-demand SSB transmission terminates.

In one example, the UE may assume the slot E+k (or slot E+k−1) includes the last candidate SSB in a burst (e.g., including the candidate SSB with the highest candidate index within a burst).

In one example, the UE may assume the slot E+k (or slot E+k−1) includes the last actually transmitted SSB in a burst (e.g., including the (last) candidate SSB with the highest actually transmitted SSB index within a burst).

In one example, the UE may assume the slot E+k+1 (or slot E+k) includes the first candidate SSB in a burst (e.g., including the candidate SSB with the candidate index 0 within a burst).

In one example, the UE may assume the slot E+k+1 (or slot E+k) includes the first actually transmitted SSB in a burst (e.g., including the (first) candidate SSB with the lowest actually transmitted SSB index within a burst).

In one example, k is the minimum integer such that the time duration from the gNB's indication (e.g., the end of the slot(s) including the gNB's indication) to the start of first actually transmitted SSB in the next slot E+k+1 (e.g., T3 as illustrated in FIG. 12) can be larger than or no less than a threshold (e.g., t_delay).

In one example, the UE may assume all actually transmitted SSB are transmitted within the slot E+k in which the on-demand SSB transmission terminates.

In one example, a UE can assume the on-demand SSB can stop to transmit (e.g., assumed not to be received by the UE) or the on-demand SSB transmission is terminated in (or from) slot E+k, wherein the slot E+k is the (first) slot after receiving the indication from the gNB subject to at least one of the examples, embodiment, and/or instances as provided in the present disclosure. For one further evaluation, the example can be applicable when the on-demand SSB transmission is indicated to be activated by the higher layer parameter (e.g., RRC). For another further evaluation, the example can be applicable when the on-demand SSB transmission is indicated to be activated by the MAC CE. For yet another further evaluation, the example can be applicable when the on-demand SSB transmission is indicated to be activated by the DCI format.

In one example, the on-demand SSB transmission can be still subject to an indication of actually transmitted SSB within the burst (e.g., further within the half frame), such that a subset of the candidate SSB occasions in the burst are used for actual transmission (e.g., ssb-PositionsInBurst or od-ssb-PositionsInBurst if provided as a dedicated parameter for on-demand SSB). In one example, the indication of actually transmitted SSB within the burst can be applicable to the candidate SSB occasions in the burst. In one example, the indication of actually transmitted SSB within the burst can be provided by at least one bitmap. In one example, the indication of actually transmitted SSB within the burst can be configured with a set of candidate values by the gNB using RRC parameter, and/or indicated by the gNB using a MAC CE or DCI format.

In one example, the slot E+k can be determined based on a further requirement that it is the first slot after the reception of the indication (e.g., ending slot of the indication) such that the duration from the reception of the indication from the gNB (e.g., the end of the slot(s) including the indication from the gNB) to the start or the end of the slot E+k can be larger than or no less than a threshold (e.g., t_delay).

In one example, the slot E+k (or the timing instance corresponding to the start or end of the slot E+k) can be determined as slot E+t_delay. In one example, this example can be applicable if slot E+t_delay is not within an on-going on-demand SSB transmission burst (e.g., slot E+t_delay does not includes candidate SSB occasion corresponding to transmitted SSB index for on-demand SSB (determined by ssb-PositionsInBurst or od-ssb-PositionsInBurst if provided as a dedicated parameter for on-demand SSB) or slot E+t_delay does not satisfy the following: not earlier than the slot including the (first) (candidate) SSB corresponding to the first actually transmitted SSB index and not later than the slot including the (last) (candidate) SSB corresponding to the last actually transmitted SSB index, and the half frame including the slot E+t_delay is with further restriction as in this embodiment).

In one example, the slot E+k can be determined based on a further requirement that it is the slot E+k including the first candidate SSB occasion within a burst, e.g., the slot includes the (first) candidate SSB corresponding to the first candidate SSB index in the burst (e.g., index 0). In one example, this example can be applicable if slot E+t_delay is within an on-going on-demand SSB transmission burst (e.g., slot E+t_delay is not earlier than the slot including the (first) (candidate) SSB corresponding to the first actually transmitted SSB index and not later than the slot including the (last) (candidate) SSB corresponding to the last actually transmitted SSB index, and the half frame including the slot E+t_delay is with further restriction as in this embodiment).

In one example, the slot E+k can be determined based on a further requirement that it is the slot E+k including the first candidate SSB occasion within a burst corresponding to the actually transmitted SSB in the burst, e.g., the UE assumes the gNB transmits from the first actually transmitted SSB within a burst, and/or the slot includes the (first) (candidate) SSB corresponding to the first actually transmitted SSB index (e.g., the index of the leftmost bit taking a value of 1 in the bitmap for actually transmitted SSB indication, or the index of the first actually transmitted SSB index based on the indication of actually transmitted SSB in the burst). In one example, this example can be applicable if slot E+t_delay is within an on-going on-demand SSB transmission burst (e.g., slot E+t_delay is not earlier than the slot including the (first) (candidate) SSB corresponding to the first actually transmitted SSB index and not later than the slot including the (last) (candidate) SSB corresponding to the last actually transmitted SSB index, and the half frame including the slot E+t_delay is with further restriction as in this embodiment).

In one example, the slot E+k can be determined based on a further requirement that it is the slot E+k including the last candidate SSB occasion within a burst, e.g., the slot includes the (last) candidate SSB corresponding to the largest candidate SSB index in the burst (e.g., highest index). In one example, this example can be applicable if slot E+t_delay is within an on-going on-demand SSB transmission burst (e.g., slot E+t_delay is not earlier than the slot including the (first) (candidate) SSB corresponding to the first actually transmitted SSB index and not later than the slot including the (last) (candidate) SSB corresponding to the last actually transmitted SSB index, and the half frame including the slot E+t_delay is with further restriction as in this embodiment).

In one example, the slot E+k (or the timing instance corresponding to the start or end of the slot E+k) can be determined based on a further requirement that it is the first slot after or no earlier than slot E+t_delay including the (last) candidate SSB occasion within a burst corresponding to the actually transmitted SSB in the burst, e.g., the slot includes the (last) (candidate) SSB occasion corresponding to the last actually transmitted SSB index (e.g., the index of the rightmost bit taking a value of 1 in the bitmap for actually transmitted SSB indication which is ssb-PositionsInBurst or od-ssb-PositionsInBurst if provided as a dedicated parameter for on-demand SSB, or the index of the last actually transmitted SSB index based on the indication of actually transmitted SSB in the burst ssb-PositionsinBurst or od-ssb-PositionsInBurst if provided as a dedicated parameter for on-demand SSB). In one example, this example can be applicable if slot E+t_delay is within an on-going on-demand SSB transmission burst (e.g., slot E+t_delay includes an candidate SSB occasion corresponding to transmitted SSB index for on-demand SSB (determined from ssb-PositionsInBurst or od-ssb-PositionsInBurst if provided as a dedicated parameter for on-demand SSB) or slot E+t_delay is not earlier than the slot including the (first) (candidate) SSB corresponding to the first actually transmitted SSB index and not later than the slot including the (last) (candidate) SSB corresponding to the last actually transmitted SSB index, and the half frame including the slot E+t_delay is with further restriction as in this embodiment).

In one example, the slot E+k can be determined based on a further requirement that the next slot E+k+1 is including the first candidate SSB occasion within a burst, e.g., the slot includes the (first) candidate SSB corresponding to the first candidate SSB index in the burst (e.g., index 0). In one example, this example can be applicable if slot E+t_delay is within an on-going on-demand SSB transmission burst (e.g., slot E+t_delay is not earlier than the slot including the (first) (candidate) SSB corresponding to the first actually transmitted SSB index and not later than the slot including the (last) (candidate) SSB corresponding to the last actually transmitted SSB index, and the half frame including the slot E+t_delay is with further restriction as in this embodiment).

In one example, the slot E+k can be determined based on a further requirement that the next slot E+k+1 is including the first candidate SSB occasion within a burst corresponding to the actually transmitted SSB in the burst, e.g., the UE assumes the gNB transmits from the first actually transmitted SSB within a burst, and/or the slot includes the (first) (candidate) SSB corresponding to the first actually transmitted SSB index (e.g., the index of the leftmost bit taking a value of 1 in the bitmap for actually transmitted SSB indication, or the index of the first actually transmitted SSB index based on the indication of actually transmitted SSB in the burst). In one example, this example can be applicable if slot E+t_delay is within an on-going on-demand SSB transmission burst (e.g., slot E+t delay is not earlier than the slot including the (first) (candidate) SSB corresponding to the first actually transmitted SSB index and not later than the slot including the (last) (candidate) SSB corresponding to the last actually transmitted SSB index, and the half frame including the slot E+t_delay is with further restriction as in this embodiment).

In one example, the slot E+k can be determined based on a further requirement that the previous slot E+k−1 is including the last candidate SSB occasion within a burst, e.g., the slot includes the (last) candidate SSB corresponding to the largest candidate SSB index in the burst (e.g., highest index). In one example, this example can be applicable if slot E+t_delay is within an on-going on-demand SSB transmission burst (e.g., slot E+t_delay is not earlier than the slot including the (first) (candidate) SSB corresponding to the first actually transmitted SSB index and not later than the slot including the (last) (candidate) SSB corresponding to the last actually transmitted SSB index, and the half frame including the slot E+t_delay is with further restriction as in this embodiment).

In one example, the slot E+k can be determined based on a further requirement that the previous slot E+k−1 is including the last candidate SSB occasion within a burst corresponding to the actually transmitted SSB in the burst, e.g., the slot includes the (last) (candidate) SSB corresponding to the last actually transmitted SSB index (e.g., the index of the rightmost bit taking a value of 1 in the bitmap for actually transmitted SSB indication, or the index of the last actually transmitted SSB index based on the indication of actually transmitted SSB in the burst). In one example, this example can be applicable if slot E+t_delay is within an on-going on-demand SSB transmission burst (e.g., slot E+t_delay is not earlier than the slot including the (first) (candidate) SSB corresponding to the first actually transmitted SSB index and not later than the slot including the (last) (candidate) SSB corresponding to the last actually transmitted SSB index, and the half frame including the slot E+t_delay is with further restriction as in this embodiment).

In one example, the slot E+k is further restricted that the half frame including the slot E+k is after the reception of the indication/trigger from the gNB (e.g., the end of the slot(s) including the indication from the gNB).

In one example, the slot E+k is further restricted that the half frame including the slot E+k can be determined as the (first) half frame from a set of half frames, wherein the set of half frames are configured (e.g., by RRC parameter for a set of candidate values) and/or indicated (e.g., MAC CE or DCI format for an index of candidate values) by the gNB using a periodicity, a frame offset (e.g., within the periodicity), and a half frame index within the frame. In one example, the set of half frames are located in frames with SFN given by (SFN mod P)=0, wherein P is the periodicity, and O is the frame offset within the periodicity, and are located in the half frames determined from the half frame indication.

In one embodiment, using a slot as a transmission unit and with explicit indication of an offset is provided.

In one example, assuming the UE receives the gNB's indication in slot E (or in slots with an ending slot as slot E), and the UE is provided with a time offset for determining the ending time of the on-demand SSB transmission (e.g., denoted by O′, which can be provided by at least one of a DCI format, a MAC CE, or a higher layer parameter), then the UE can determine the slot in which the on-demand SSB transmission terminates (or in which no on-demand SSB transmission starts) as E+O′.

In one example, the UE may assume all actually transmitted SSB are transmitted within the slot E+O′ in which the on-demand SSB transmission terminates.

In one example, the UE may assume the unit of the time offset O′ is a slot. In one example, O′=0 refers to the case that on-demand SSB transmission terminates in the slot same as the one in which the UE receives the gNB's indication.

In one example, the UE may assume that O′ can be larger than or no less than a threshold (e.g., t_delay).

In one example, the UE may assume that the time duration from the gNB's indication (e.g., the end of the slot including the gNB's indication) to the end of the last actually transmitted SSB in the slot E+O′ (e.g., T1 as illustrated in FIG. 12) can be larger than or no less than a threshold (e.g., t_delay).

In one example, the UE may assume that the time duration from the gNB's indication (e.g., the end of the slot including the gNB's indication) to the end of the slot E+O′ (e.g., T2 as illustrated in FIG. 12) can be larger than or no less than a threshold (e.g., t_delay).

In one example, the UE may assume that the time duration from the gNB's indication (e.g., the end of the slot including the gNB's indication) to the start of first actually transmitted SSB in the next slot E+O′+1 (e.g., T3 as illustrated in FIG. 12) can be larger than or no less than a threshold (e.g., t_delay).

In one example, the UE may assume the slot E+O′ (or slot E+O′−1) includes the last candidate SSB in a burst (e.g., including the candidate SSB with the highest candidate index within a burst).

In one example, the UE may assume the slot E+O′ (or slot E+O′−1) includes the last actually transmitted SSB in a burst (e.g., including the (last) candidate SSB with the highest actually transmitted SSB index within a burst).

In one example, the UE may assume the slot E+O′+1 (or slot E+O′) includes the first candidate SSB in a burst (e.g., including the candidate SSB with the candidate index 0 within a burst).

In one example, the UE may assume the slot E+O′+1 (or slot E+O′) includes the first actually transmitted SSB in a burst (e.g., including the (first) candidate SSB with the lowest actually transmitted SSB index within a burst).

In one example, the slot E+O′ is further restricted that the half frame including the slot E+k is after the reception of the indication/trigger from the gNB (e.g., the end of the slot(s) including the indication from the gNB).

In one example, the slot E+O′ is further restricted that the half frame including the slot E+k can be determined as the (first) half frame from a set of half frames, wherein the set of half frames are configured (e.g., RRC parameter) or indicated (e.g., MAC CE or DCI format) by the gNB using a periodicity, a frame offset within the periodicity, and a half frame index within the frame. In one example, the set of half frames are located in frames with SFN given by (SFN mod P)=O, wherein P is the periodicity, and O is the frame offset within the periodicity, and the set of half frames have a half frame index configured or indicated by the gNB.

In one embodiment, an operation without explicit indication is provided.

In one example, the UE can determine the slot in which the on-demand SSB transmission terminates (or in which no on-demand SSB transmission starts) without gNB's explicit indication. For one further evaluation, the example can be applicable when the on-demand SSB transmission is indicated to be activated by the higher layer parameter (e.g., RRC). For another further evaluation, the example can be applicable when the on-demand SSB transmission is indicated to be activated by the MAC CE. For yet another further evaluation, the example can be applicable when the on-demand SSB transmission is indicated to be activated by the DCI format.

In one example, if a UE is configured with and/or provided with a counter related to the on-demand SSB transmission, wherein the counter is a number of on-demand SSB transmission bursts, then the UE assumes the on-demand SSB transmission terminates after the counter achieves 0 (e.g., terminates at the slot including the (last) (candidate) SSB corresponding to the last actually transmitted SSB index in the last SSB transmission burst).

In one example, if a UE is configured with and/or provided with a timer related to the on- demand SSB transmission, then the UE assumes the on-demand SSB transmission terminates when the timer expires.

In one example, if a UE is configured with and/or provided with a timer related to the activation or deactivation of the SCell, then the UE assumes the on-demand SSB transmission terminates when the timer expires. In one example, this example can be applicable if the slot where the timer expires is not within an on-going on-demand SSB transmission burst (e.g., the slot does not satisfy the following: not earlier than the slot including the (first) (candidate) SSB corresponding to the first actually transmitted SSB index and not later than the slot including the (last) (candidate) SSB occasion corresponding to the last actually transmitted SSB index, and the half frame including the slot is with further restriction as in this embodiment).

In one example, if a UE is configured with and/or provided with a timer related to the activation or deactivation of the SCell, then the UE assumes the on-demand SSB transmission terminates at the first slot including the last candidate SSB occasion within a burst corresponding to the actually transmitted SSB in the burst, e.g., the slot includes the (last) (candidate) SSB corresponding to the last actually transmitted SSB index (e.g., the index of the rightmost bit taking a value of 1 in the bitmap for actually transmitted SSB indication, or the index of the last actually transmitted SSB index based on the indication of actually transmitted SSB in the burst), and the half frame including the slot is with further restriction as in this embodiment. In one example, this example can be applicable if the slot where the timer expires is within an on-going on-demand SSB transmission burst (e.g., the slot is not earlier than the slot including the (first) (candidate) SSB corresponding to the first actually transmitted SSB index and not later than the slot including the (last) (candidate) SSB corresponding to the last actually transmitted SSB index, and the half frame including the slot is with further restriction as in this embodiment).

In one example, if a UE is configured with and/or provided with a timer related to the activation or deactivation of the SCell, then the UE assumes the on-demand SSB transmission terminates when the timer expires. In one example, this example can be applicable if the slot where the timer expires is not within a half frame that is with further restriction as in this embodiment.

In one example, if a UE is configured with and/or provided with a timer related to the activation or deactivation of the SCell, then the UE assumes the on-demand SSB transmission terminates at the first slot including the last candidate SSB occasion within a burst or the first slot that is the last slot of a half frame, and the half frame including the slot is with further restriction as in this embodiment. In one example, this example can be applicable if the slot where the timer expires is within a half frame that is with further restriction as in this embodiment.

In one example, if a UE determines a SCell is activated, then the UE assumes the on- demand SSB transmission terminates at the slot where the UE determines the SCell is activated. In one example, this example can be applicable if the slot where the timer expires is not within a half frame that is with further restriction as in this embodiment.

In one example, if a UE determines a SCell is activated, then the UE assumes the on- demand SSB transmission terminates at the first slot including the last candidate SSB occasion within a burst or the first slot that is the last slot of a half frame, and the half frame including the slot is with further restriction as in this embodiment. In one example, this example can be applicable if the slot where the timer expires is within a half frame that is with further restriction as in this embodiment.

In one embodiment, a UE procedure is provided.

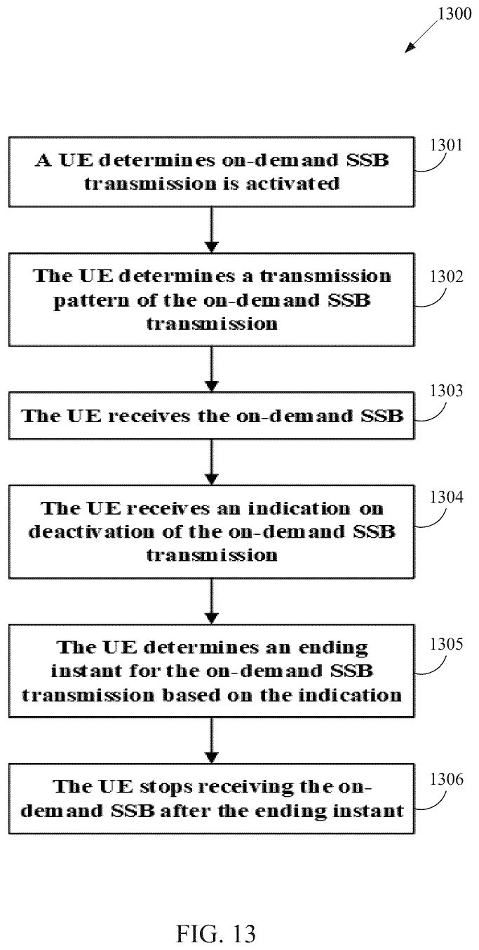

FIG. 13 illustrates a flowchart of UE method 1300 for an on-demand SSB according to embodiments of the present disclosure. The UE method 1300 as may be performed by a UE (e.g., 111-116 as illustrated in FIG. 1). An embodiment of the UE method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

An example UE procedure for determining the ending time for on-demand SSB transmission based on gNB's indication is shown in FIG. 13.

As illustrated in FIG. 13, in step 1301, a UE determines whether an on-demand SSB transmission is activated. Subsequently, in step 1302, the UE determines a transmission pattern of the on-demand SSB transmission. Subsequently, in step 1303, the UE receives the on-demand SSB. Subsequently, in step 1304, the UE receives an indication on deactivation of the on-demand SSB transmission. Next, in step 1305, the UE determines an ending instant for the on-demand SSB transmission based on the indication. Finally, in step 1306, the UE stops receiving the on-demand SSB after the ending instant.

In one embodiment, a transmission ending time based on UE's triggering is provided.

In one embodiment, a UE can determine the on-demand SSB transmission is deactivated (or no on-demand SSB is transmitted) based on the UE's triggering.

In one example, the UE's triggering can be UE assistant information including an indication of SCell deactivation and/or on-demand SSB transmission deactivation.

In one example, the UE's triggering can be an uplink MAC CE including an indication of SCell deactivation and/or on-demand SSB transmission deactivation.

In one example, the UE's triggering can be UCI including an indication of SCell deactivation and/or on-demand SSB transmission deactivation.

In one example, the UE's triggering can be UCI or an uplink MAC CE including a L1 measurement report, which is for example used for indicating a SCell is activated.

In one example, after the UE determines the on-demand SSB transmission is deactivated, the UE may not perform RRM measurement, and/or synchronization, and/or L1 measurement based on the on-demand SSB.

In one embodiment, using a half frame as a transmission unit and without explicit indication of an offset is provided.

In one example, assuming the UE transmits the UL trigger in half frame E (or in half frames with an ending half frame as half frame E), then the UE can determine the half frame in which the on-demand SSB transmission terminates (or in which no on-demand SSB transmission starts) as E+k, wherein k can be given by at least one of the examples (e.g., k is in a unit of a half frame) as provided in the present disclosure.

In one example, k=0, e.g., the UE assumes on-demand SSB transmission terminates in the half frame same as the one in which the UE receives the gNB's indication.

In one example, k is the minimum integer such that the time duration from the UE's triggering (e.g., the end of the symbol/slot including the UE triggering) to the end of the last actually transmitted SSB in the half frame E+k can be larger than or no less than a threshold (e.g., t_delay).

In one example, k is the minimum integer such that the time duration from the UE's triggering (e.g., the end of the symbol/slot including the UE triggering) to the end of the half frame E+k can be larger than or no less than a threshold (e.g., t_delay).

In one example, k is the minimum integer such that the time duration from the UE's triggering (e.g., the end of the symbol/slot including the UE triggering) to the start of first actually transmitted SSB in the next half frame E+k+1 can be larger than or no less than a threshold (e.g., t_delay).

In one embodiment, using a half frame as a transmission unit and with explicit indication of an offset is provided.

In one example, assuming the UE transmits the UL trigger in half frame E (or in half frames with an ending half frame as half frame E), and the UE provides a time offset for determining the ending time of the on-demand SSB transmission (e.g., denoted by O′, which can be provided by at least one of UCI, an uplink MAC CE, or a higher layer parameter), then the UE can determine the half frame in which the on-demand SSB transmission terminates (or in which no on-demand SSB transmission starts) as E+O′.

In one example, the UE may assume all actually transmitted SSB are transmitted within the half frame E+O′ in which the on-demand SSB transmission terminates.

In one example, the UE may assume the unit of the time offset O′ is a half frame or a SSB transmission burst. In one example, O′=0 refers to the case that on-demand SSB transmission terminates in the half frame same as the one in which the UE transmits the UL trigger.

In one example, the UE may assume that O′ can be larger than or no less than a threshold (e.g., t_delay).

In one example, the UE may assume that the time duration from transmitting the UL trigger (e.g., the end of the slot(s) including the UL trigger) to the end of the last actually transmitted SSB in the half frame E+O′ can be larger than or no less than a threshold (e.g., t_delay).

In one example, the UE may assume that the time duration from transmitting the UL trigger (e.g., the end of the slot(s) including the UL trigger) to the end of the half frame E+O′ can be larger than or no less than a threshold (e.g., t_delay).

In one example, the UE may assume that the time duration from transmitting the UL trigger (e.g., the end of the slot(s) including the UL trigger) to the start of first actually transmitted SSB in the next half frame E+O′+1 can be larger than or no less than a threshold (e.g., t_delay).

In one embodiment, using a slot as a transmission unit and without explicit indication of an offset is provided.

In one example, assuming the UE transmits the UL trigger in slot E (or in slots with an ending slot as slot E), then the UE can determine the slot in which the on-demand SSB transmission terminates (or in which no on-demand SSB transmission starts) as E+k, wherein k can be given by at least one of the examples (e.g., k is in a unit of a slot) as provided in the present disclosure.

In one example, k=0, e.g., the UE assumes on-demand SSB transmission terminates in the slot same as the one in which the UE transmits the UL trigger.

In one example, k is the minimum integer such that the time duration from the UE's triggering (e.g., the end of the symbol(s)/slot(s) including the UE triggering) to the end of the last actually transmitted SSB in the slot E+k can be larger than or no less than a threshold (e.g., t_delay).

In one example, k is the minimum integer such that the time duration from the UE's triggering (e.g., the end of the symbol(s)/slot(s) including the UE triggering) to the end of the slot E+k can be larger than or no less than a threshold (e.g., t_delay).

In one example, the UE may assume the slot E+k (or slot E+k−1) includes the last candidate SSB in a burst (e.g., including the candidate SSB with the highest candidate index within a burst).

In one example, the UE may assume the slot E+k (or slot E+k−1) includes the last actually transmitted SSB in a burst (e.g., including the (last) candidate SSB with the highest actually transmitted SSB index within a burst).

In one example, the UE may assume the slot E+k+1 (or slot E+k) includes the first candidate SSB in a burst (e.g., including the candidate SSB with the candidate index 0 within a burst).

In one example, the UE may assume the slot E+k+1 (or slot E+k) includes the first actually transmitted SSB in a burst (e.g., including the (first) candidate SSB with the lowest actually transmitted SSB index within a burst).

In one example, k is the minimum integer such that the time duration from the UE's triggering (e.g., the end of the symbol(s)/slot(s) including the UE triggering) to the start of first actually transmitted SSB in the next slot E+k+1 can be larger than or no less than a threshold (e.g., t_delay).

In one example, a UE can assume the on-demand SSB can stop to transmit (e.g., assumed not to be received by the UE) or the on-demand SSB transmission is terminated in slot E +k, wherein the slot E+k is the first slot after transmitting the UL trigger subject to at least one of the examples, embodiments, and/or instances as provided in the present disclosure.

In one example, the on-demand SSB transmission can be still subject to an indication of actually transmitted SSB within the burst (e.g., further within the half frame), such that a subset of the candidate SSB occasions in the burst are used for actual transmission. In one example, the indication of actually transmitted SSB within the burst can be applicable to the candidate SSB occasions in the burst. In one example, the indication of actually transmitted SSB within the burst can be provided by at least one bitmap.

In one example, the slot E+k can be determined based on a further requirement that the duration from transmitting the UL trigger (e.g., the end of the slot(s) including the UL trigger) to the start or the end of the slot can be larger than or no less than a threshold (e.g., t_delay).

In one example, the slot E+k can be determined based on a further requirement that it is the slot E+k including the first candidate SSB occasion within a burst, e.g., the slot includes the (first) candidate SSB corresponding to the first candidate SSB index in the burst (e.g., index 0).

In one example, the slot E+k can be determined based on a further requirement that it is the slot E+k including the first candidate SSB occasion within a burst corresponding to the actually transmitted SSB in the burst, e.g., the UE assumes the gNB transmits from the first actually transmitted SSB within a burst, and/or the slot includes the (first) (candidate) SSB corresponding to the first actually transmitted SSB index (e.g., the index of the leftmost bit taking a value of 1 in the bitmap for actually transmitted SSB indication, or the index of the first actually transmitted SSB index based on the indication of actually transmitted SSB in the burst).

In one example, the slot E+k can be determined based on a further requirement that it is the slot E+k including the last candidate SSB occasion within a burst, e.g., the slot includes the (last) candidate SSB corresponding to the largest candidate SSB index in the burst (e.g., highest index).

In one example, the slot E+k can be determined based on a further requirement that it is the slot E+k including the last candidate SSB occasion within a burst corresponding to the actually transmitted SSB in the burst, e.g., the slot includes the (last) (candidate) SSB corresponding to the last actually transmitted SSB index (e.g., the index of the rightmost bit taking a value of 1 in the bitmap for actually transmitted SSB indication, or the index of the last actually transmitted SSB index based on the indication of actually transmitted SSB in the burst).

In one example, the slot E+k can be determined based on a further requirement that the next slot E+k+1 is including the first candidate SSB occasion within a burst, e.g., the slot includes the (first) candidate SSB corresponding to the first candidate SSB index in the burst (e.g., index 0).

In one example, the slot E+k can be determined based on a further requirement that the next slot E+k+1 is including the first candidate SSB occasion within a burst corresponding to the actually transmitted SSB in the burst, e.g., the UE assumes the gNB transmits from the first actually transmitted SSB within a burst, and/or the slot includes the (first) (candidate) SSB corresponding to the first actually transmitted SSB index (e.g., the index of the leftmost bit taking a value of 1 in the bitmap for actually transmitted SSB indication, or the index of the first actually transmitted SSB index based on the indication of actually transmitted SSB in the burst).

In one example, the slot E+k can be determined based on a further requirement that the previous slot E+k−1 is including the last candidate SSB occasion within a burst, e.g., the slot includes the (last) candidate SSB corresponding to the largest candidate SSB index in the burst (e.g., highest index).

In one example, the slot E+k can be determined based on a further requirement that the previous slot E+k−1 is including the last candidate SSB occasion within a burst corresponding to the actually transmitted SSB in the burst, e.g., the slot includes the (last) (candidate) SSB corresponding to the last actually transmitted SSB index (e.g., the index of the rightmost bit taking a value of 1 in the bitmap for actually transmitted SSB indication, or the index of the last actually transmitted SSB index based on the indication of actually transmitted SSB in the burst).

In one embodiment, using a slot as a transmission unit and with explicit indication of an offset is provided.

In one example, assuming the UE transmits the UL trigger in slot E (or in slots with an ending slot as slot E), and the UE provides with a time offset for determining the ending time of the on-demand SSB transmission (e.g., denoted by O′, which can be provided by at least one of UCI, an uplink MAC CE, or a higher layer parameter), then the UE can determine the slot in which the on-demand SSB transmission terminates (or in which no on-demand SSB transmission starts) as E+O′.

In one example, the UE may assume all actually transmitted SSB are transmitted within the slot E+O′ in which the on-demand SSB transmission terminates.

In one example, the UE may assume the unit of the time offset O′ is a slot. In one example, 0′=0 refers to the case that on-demand SSB transmission terminates in the slot same as the one in which the UE receives the gNB's indication.

In one example, the UE may assume that O′ can be larger than or no less than a threshold (e.g., t_delay).

In one example, the UE may assume that the time duration from transmitting the UL trigger to the end of the last actually transmitted SSB in the slot E+O′ can be larger than or no less than a threshold (e.g., t_delay).

In one example, the UE may assume that the time duration from transmitting the UL trigger to the end of the slot E+O′ can be larger than or no less than a threshold (e.g., t_delay).

In one example, the UE may assume that the time duration from transmitting the UL trigger to the start of first actually transmitted SSB in the next slot E+O′+1 can be larger than or no less than a threshold (e.g., t_delay).

In one example, the UE may assume the slot E+O′ (or slot E+O′−1) includes the last candidate SSB in a burst (e.g., including the candidate SSB with the highest candidate index within a burst).

In one example, the UE may assume the slot E+O′ (or slot E+O′−1) includes the last actually transmitted SSB in a burst (e.g., including the (last) candidate SSB with the highest actually transmitted SSB index within a burst).

In one example, the UE may assume the slot E+O′+1 (or slot E+O′) includes the first candidate SSB in a burst (e.g., including the candidate SSB with the candidate index 0 within a burst).

In one example, the UE may assume the slot E+O′+1 (or slot E+O′) includes the first actually transmitted SSB in a burst (e.g., including the (first) candidate SSB with the lowest actually transmitted SSB index within a burst).

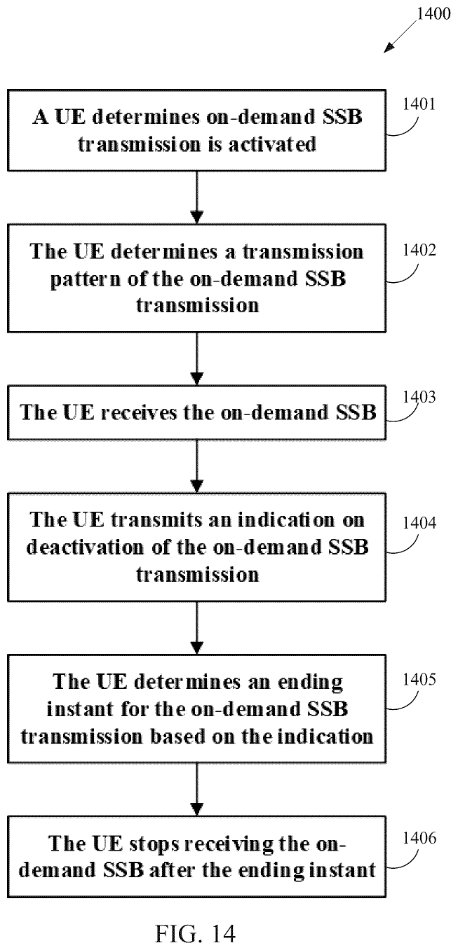

An example UE procedure for determining the ending time for on-demand SSB transmission based on UE's triggering is shown in FIG. 14.

FIG. 14 illustrates another flowchart of UE method 1400 for an on-demand SSB according to embodiments of the present disclosure. The UE method 1400 as may be performed by a UE (e.g., 111-116 as illustrated in FIG. 1). An embodiment of the UE method 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

As illustrated in FIG. 14, in step 1401, a UE determines whether an on-demand SSB transmission is activated. Subsequently, in step 1402, the UE determines a transmission pattern of the on-demand SSB transmission. Subsequently, in step 1403, the UE receives the on-demand SSB. Subsequently, in step 1404, the UE transmits an indication on deactivation of the on-demand SSB transmission. Next, in step 1405, the UE determines an ending instant for the on-demand SSB transmission based on the indication. Finally, in step 1406, the UE stops receiving the on-demand SSB after the ending instant.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to:
receive a first set of higher layer parameters, wherein the first set of higher layer parameters includes a set of configurations for on-demand synchronization signal and physical broadcast channel (SS/PBCH) blocks; and
receive a medium access control (MAC) control element (CE); and
a processor operably coupled to the transceiver, the processor configured to:
identify, based on the set of configurations, a set of transmitted SS/PBCH blocks in a burst;
determine a last transmitted SS/PBCH block in the burst;
identify, based on the MAC CE, a first indication of deactivation of transmission for the on-demand SS/PBCH blocks;
determine a first slot corresponding to T slots after a slot where the MAC CE ends, where T is a positive integer; and
determine, based on whether the first slot includes a transmitted SS/PBCH block in the burst, a second slot as an end of the transmission for the on-demand SS/PBCH blocks.

2. The UE of claim 1, wherein:
the second slot is determined as the first slot when the first slot does not include the transmitted SS/PBCH block in the burst; and
the second slot is determined as a first upcoming slot no earlier than the first slot that includes the last transmitted SS/PBCH block in the burst when the first slot includes the transmitted SS/PBCH block in the burst.

3. The UE of claim 2, wherein T corresponds to a minimum processing time for the MAC CE.

4. The UE of claim 1, wherein the processor is further configured to:
identify, based on the set of configurations, a periodicity, a system frame number (SFN) offset for a frame within the periodicity, and a half-frame index within the frame; and
determine a set of half-frames as candidate half frames for the transmission of the on-demand SS/PBCH blocks.

5. The UE of claim 4, wherein the first slot is determined to include the transmitted SS/PBCH block in the burst when the first slot is within the set of half-frames.

6. The UE of claim 1, wherein:
the processor is further configured to identify, based on the set of configurations, a number of transmitted SS/PBCH block bursts; and
the second slot is determined based on the number of transmitted SS/PBCH block bursts and the last transmitted SS/PBCH block in the burst.

7. The UE of claim 1, wherein:
the transceiver is further configured to receive a second set of higher layer parameters;
the processor is further configured to identify, based on the second set of higher layer parameters, a second indication of deactivation of transmission for the on-demand SS/PBCH blocks; and
the second slot is determined based on a third slot in which the second set of higher layer parameters are received.

8. A base station (BS) in a wireless communication system, the BS comprising:
a processor configured to:
determine a first set of higher layer parameters, wherein the first set of higher layer parameters includes a set of configurations for on-demand synchronization signal and physical broadcast channel (SS/PBCH) blocks;
identify, based on the set of configurations, a set of transmitted SS/PBCH blocks in a burst;
determine a last transmitted SS/PBCH block in the burst; and
determine a first indication of deactivation of transmission for the on-demand SS/PBCH blocks; and
a transceiver operably coupled to the processor, the transceiver configured to:
transmit the first set of higher layer parameters; and
transmit a medium access control (MAC) control element (CE) including the first indication,
wherein the processer further configured to:
determine a first slot corresponding to T slots after a slot where the MAC CE ends, where T is a positive integer; and
determine, based on whether the first slot includes a transmitted SS/PBCH block in the burst, a second slot as an end of the transmission for the on-demand SS/PBCH blocks.

9. The BS of claim 8, wherein:
the second slot is determined as the first slot when the first slot does not include the transmitted SS/PBCH block in the burst; and
the second slot is determined as a first upcoming slot no earlier than the first slot that includes the last transmitted SS/PBCH block in the burst when the first slot includes the transmitted SS/PBCH block in the burst.

10. The BS of claim 8, wherein T corresponds to a minimum processing time for the MAC CE.

11. The BS of claim 8, wherein the processor is further configured to:
identify, based on the set of configurations, a periodicity, a system frame number (SFN) offset for a frame within the periodicity, and a half-frame index within the frame; and
determine a set of half-frames as candidate half frames for the transmission of the on-demand SS/PBCH blocks.

12. The BS of claim 11, wherein the first slot is determined to include the transmitted SS/PBCH block in the burst when the first slot is within the set of half-frames.

13. The BS of claim 8, wherein:
the processor is further configured to identify, based on the set of configurations, a number of transmitted SS/PBCH block bursts; and
the second slot is determined based on the number of transmitted SS/PBCH block bursts and the last transmitted SS/PBCH block in the burst. 14 The BS of claim 8, wherein:
the transceiver is further configured to transmit a second set of higher layer parameters;
the processor is further configured to identify, based on the second set of higher layer parameters, a second indication of deactivation of transmission for the on-demand SS/PBCH blocks; and
the second slot is determined based on a third slot in which the second set of higher layer parameters are received.

15. A method of a user equipment (UE) in a wireless communication system, the method comprising:
receiving a first set of higher layer parameters, wherein the first set of higher layer parameters includes a set of configurations for on-demand synchronization signal and physical broadcast channel (SS/PBCH) blocks;
receiving a medium access control (MAC) control element (CE);
identifying, based on the set of configurations, a set of transmitted SS/PBCH blocks in a burst;
determining a last transmitted SS/PBCH block in the burst;
identifying, based on the MAC CE, a first indication of deactivation of transmission for the on-demand SS/PBCH blocks;
determining a first slot corresponding to T slots after a slot where the MAC CE ends, where T is a positive integer; and
determining, based on whether the first slot includes a transmitted SS/PBCH block in the burst, a second slot as an end of the transmission for the on-demand SS/PBCH blocks.

16. The method of claim 15, wherein:
the second slot is determined as the first slot when the first slot does not include the transmitted SS/PBCH block in the burst; and
the second slot is determined as a first upcoming slot no earlier than the first slot that includes the last transmitted SS/PBCH block in the burst when the first slot includes the transmitted SS/PBCH block in the burst.

17. The method of claim 15, wherein T corresponds to a minimum processing time for the MAC CE.

18. The method of claim 15, further comprising:
identifying, based on the set of configurations, a periodicity, a system frame number (SFN) offset for a frame within the periodicity, and a half-frame index within the frame;
determining a set of half-frames as candidate half frames for the transmission of the on- demand SS/PBCH blocks; and
the first slot is determined to include the transmitted SS/PBCH block in the burst when the first slot is within the set of half-frames.

19. The method of claim 15, further comprising:
identifying, based on the set of configurations, a number of transmitted SS/PBCH block bursts,
wherein the second slot is determined based on the number of transmitted SS/PBCH block bursts and the last transmitted SS/PBCH block in the burst.

20. The method of claim 15, further comprising:
receiving a second set of higher layer parameters; and
identifying, based on the second set of higher layer parameters, a second indication of deactivation of transmission for the on-demand SS/PBCH blocks,
wherein the second slot is determined based on a third slot in which the second set of higher layer parameters are received.
